(19) United States
(12) Patent Application Publication
(10) Pub. No.: US 2018/0374493 A1
(43) Pub. Date: Dec. 27, 2018

(54) SYSTEM, CONTROL METHOD, AND CONTROL TERMINAL

(71) Applicant: YAMAHA CORPORATION, Hamamatsu-shi (JP)

(72) Inventors: Atsushi USUI, Hamamatsu-shi (JP); Masaya KANO, Hamamatsu-shi (JP)

(21) Appl. No.: 16/117,231

(22) Filed: Aug. 30, 2018

Related U.S. Application Data
(63) Continuation of application No. PCT/JP2017/003690, filed on Feb. 2, 2017.

(30) Foreign Application Priority Data
Mar. 4, 2016 (JP) 2016-042158

(51) Int. Cl. G10L 19/16; G10L 21/0208; G10L 21/038

(52) U.S. Cl. CPC G10L 19/173; G10L 21/038; G10L 21/0208

(57) ABSTRACT

Provided is a system including: a first reproduction device including a first signal processor and being configured to reproduce audio data; a second reproduction device configured to reproduce the audio data, wherein the first reproduction device is configured to: receive the audio data from a content server in response to a request for reproduction of the audio data by the second reproduction device; cause the first signal processor to execute predetermined signal processing on the received audio data; and transfer the audio data subjected to the predetermined signal processing to the second reproduction device.

### CROSS-REFERENCE TO RELATED APPLICATION

The present application is continuation of International Application No. PCT/JP2017/003690 filed on Feb. 2, 2017, which claims priority from Japanese application JP2016-042158 filed on Mar. 4, 2016. The content of those applications are hereby incorporated by reference into this application.

### BACKGROUND OF THE INVENTION

### 1. Field of the Invention

The present invention relates to a system, which includes a plurality of audio devices to be connected to one another via a network, a control method, and a control terminal.

### 2. Description of the Related Art

Hitherto, there has been known a technology of converting, when content is distributed to a device, for example, a mobile terminal, via a network, substance of the content depending on the capability of a distribution target device. For example, in WO2011/010601A1, there is described a gateway device configured to convert content in accordance with, for example, specifics of conversion of a codec, depending on the capability of a mobile terminal that has requested streaming or a file.

### SUMMARY OF THE INVENTION

Meanwhile, there is known an audiovisual (AV) system including a plurality of reproduction devices and having a capability of, for example, causing the plurality of reproduction devices to reproduce the same acoustic data at the same time. Specifically, the AV system is constructed by connecting the plurality of reproduction devices to one another via a network or an audio cable, and each reproduction device receives acoustic data from, for example, a content server providing the acoustic data for reproduction.

When the capabilities of the plurality of reproduction devices constructing the AV system are different from one another, there may be both of a reproduction device that can reproduce the acoustic data and a reproduction device that cannot reproduce the acoustic data depending on the format of the acoustic data. Thus, when the same acoustic data is to be reproduced by the plurality of reproduction devices, for example, acoustic data of a low sound quality is required to be selected, although there is a reproduction device that can reproduce acoustic data of a high sound quality.

Alternatively, it is conceivable to employ WO2011/010601A1 described above so that the plurality of reproduction devices each receive acoustic data that suits the capability of each device. However, in this case, the content server is required to distribute the same number of pieces of acoustic data as the number of reproduction devices.

The present application has been proposed in view of the above-mentioned problem, and has an object to provide a system, a control method, and a computer-readable information storage medium, which are capable of achieving, in a system including a plurality of reproduction devices, reproduction with a sound quality that suits the capability of each device through transfer of the smallest amount of acoustic data possible by providing acoustic data in a data format processable by each device.

According to one embodiment of the present application, there is provided a system including: a first reproduction device including a first signal processor and being configured to reproduce audio data; and a second reproduction device configured to reproduce the audio data, wherein the first reproduction device is configured to: receive the audio data from a content server providing the audio data in response to a request for reproduction of the audio data by the second reproduction device; cause the first signal processor to execute predetermined signal processing on the received audio data; and transfer the audio data subjected to the predetermined signal processing to the second reproduction device.

According to one embodiment of the present application, there is provided a control method including: receiving, by a first reproduction device including a first signal processor and being configured to reproduce audio data, the audio data from a content server configured to provide the audio data, in response to a request for reproduction of the audio data by a second reproduction device configured to reproduce the audio data; causing, by the first reproduction device, the first signal processor to execute predetermined signal processing on the received audio data; and transferring, by the first reproduction device, the audio data subjected to the predetermined signal processing to the second reproduction device.

According to one embodiment of the present application, there is provided a control terminal, which is configured to: cause a first reproduction device including a first signal processor and being configured to reproduce audio data to receive the audio data from a content server configured to provide the audio data, in response to a request for reproduction of the audio data by a second reproduction device configured to reproduce the audio data; cause the first reproduction device to cause the first signal processor to execute predetermined signal processing on the received audio data; and cause the first reproduction device to transfer the audio data subjected to the signal processing to the second reproduction device.

According to one embodiment of the present application, there is provided a computer-readable information storage medium having stored thereon a program for causing a computer to execute processing of performing control of: causing a first reproduction device including a first signal processor and being configured to reproduce audio data to receive the audio data from a content server configured to provide the audio data, in response to a request for reproduction of the audio data by a second reproduction device configured to reproduce the audio data; causing the first reproduction device to cause the first signal processor to execute predetermined signal processing on the received audio data; and causing the first reproduction device to transfer the audio data subjected to the predetermined signal processing to the second reproduction device.

### BRIEF DESCRIPTION OF THE DRAWINGS

FIG. 1 is a diagram for illustrating an entire configuration of a system according to a first embodiment of the present invention.

FIG. 2 is a block diagram for illustrating a configuration of a first reproduction device.

FIG. 3 is a block diagram for illustrating a configuration of a second reproduction device.

FIG. 4 is a flowchart for illustrating details of reproduction processing.

FIG. 5 is a flowchart for illustrating details of reproduction processing in a modification example of the present invention.

FIG. 6 is a diagram for illustrating an entire configuration of a system according to a second embodiment of the present invention.

### DETAILED DESCRIPTION OF THE INVENTION

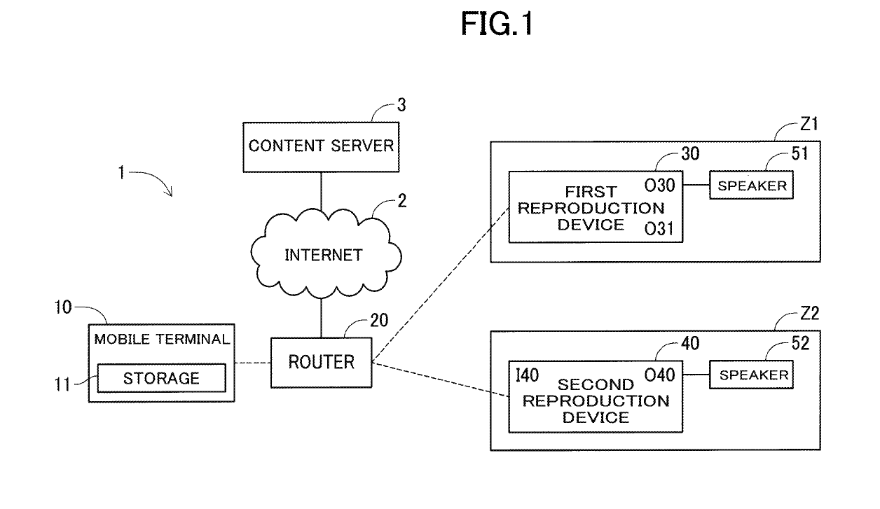

Now, a description is given of an entire configuration of a system 1 according to a first embodiment of the present invention with reference to FIG. 1. The system 1 includes an Internet 2, a content server 3, a mobile terminal 10, a router 20, a first reproduction device 30, a second reproduction device 40, and speakers 51 and 52. The mobile terminal 10, the first reproduction device 30, and the second reproduction device 40 construct a LAN via the router 20. The mobile terminal 10, the first reproduction device 30, and the second reproduction device 40 each have a wireless LAN function, and can communicate to/from one another in a wireless manner. The first reproduction device 30 and the speaker 51 are arranged in a zone Z1, whereas the second reproduction device 40 and the speaker 52 are arranged in a zone Z2. The zones Z1 and Z2 in this case refer to, for example, a kitchen and a living room, respectively. The speaker 51 is connected to the first reproduction device 30. Further, the speaker 52 is connected to the second reproduction device 40.

The content server 3 is connected to the Internet 2, and provides its content, for example, audio data, in response to a request. The router 20 serves as a relay between the LAN and the Internet 2. Further, the router 20 functions as a wireless LAN access point. The first reproduction device 30 and the second reproduction device 40 are each, for example, an AV amplifier or an AV receiver having functions such as a communication function and a reproduction function. The mobile terminal 10 is, for example, a cell phone, a smartphone, or a tablet terminal including, for example, a storage 11. The mobile terminal 10 has a pre-installed application for receiving an instruction from a user to control the first reproduction device 30 and the second reproduction device 40 via the wireless LAN, to thereby function as a controller configured to control the first reproduction device 30 and the second reproduction device 40. The speakers 51 and 52 emit sound in accordance with input audio data.

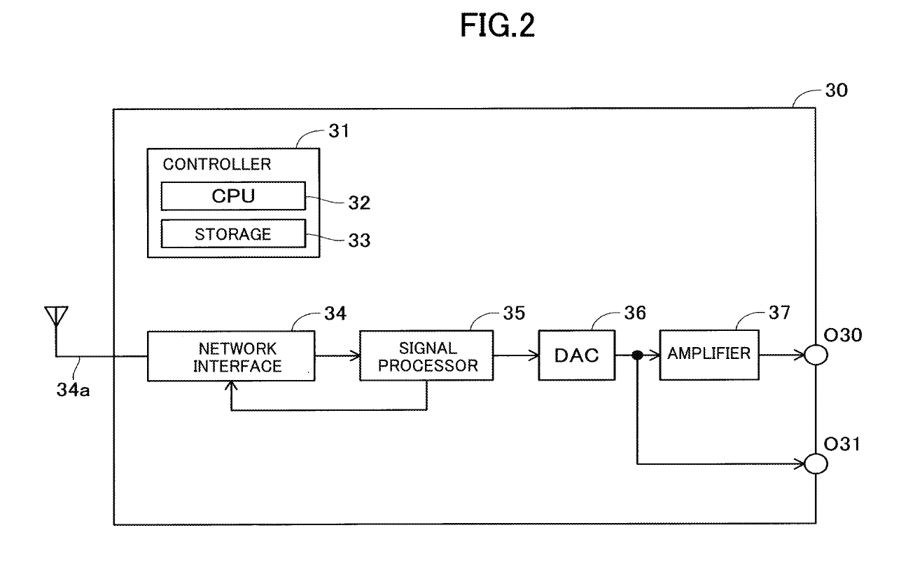

Next, a description is given of an electric configuration of the first reproduction device 30 with reference to FIG. 2.

The first reproduction device 30 includes, for example, output terminals O30 and O31, a controller 31, a network interface 34, a signal processor 35, a digital-to-analog converter (DAC) 36, and an amplifier 37. The first reproduction device 30 has a function of reproducing audio data received via the network interface 34, and a function of transmitting audio data, which has been output from the signal processor 35, via the network interface 34.

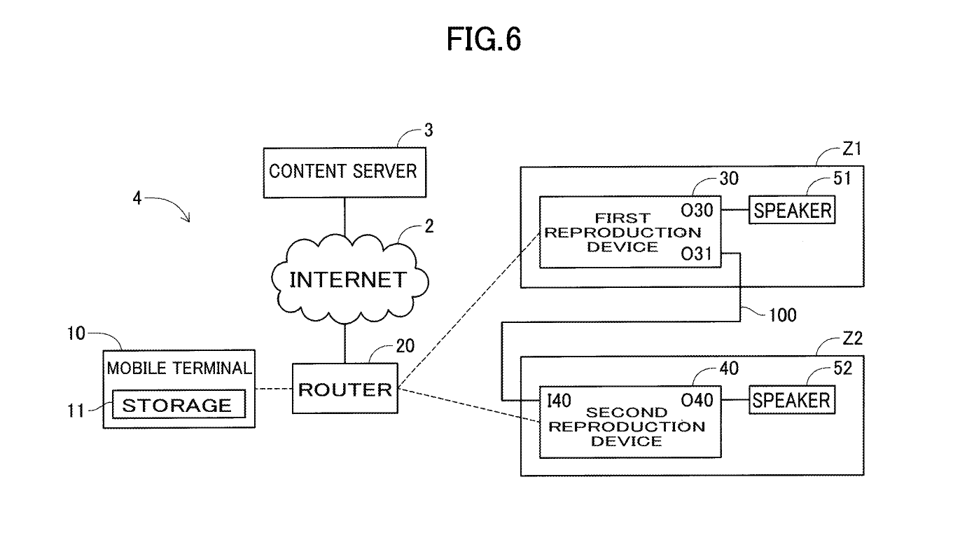

The output terminal O30 is a terminal to which the speaker 51 is to be connected. The output terminal O31 is a terminal to which an audio cable 100 (described later with reference to FIG. 6) is to be connected. The controller 31 includes, for example, a CPU 32 and a storage 33. The CPU 32 executes various programs stored in the storage 33, to thereby control, for example, the network interface 34, the signal processor 35, the DAC 36, and the amplifier 37, which are connected thereto via a bus (not shown). The network interface 34 has a function of demodulating a radio wave received via the antenna 34a and generating a radio wave to be transmitted. The first reproduction device 30 can communicate to/from, for example, the mobile terminal 10 and the second reproduction device 40 via the wireless LAN.

The signal processor 35 outputs audio data, which has been created by executing predetermined signal processing on the received audio data, to the DAC 36 and the network interface 34. The signal processing herein refers to, for example, conversion processing and band expansion processing. The conversion processing is processing of converting received audio data in a direct stream digital (DSD) format to audio data in a pulse code modulation (PCM) format, and the band expansion processing is processing of generating audio data to which data in a certain frequency band is added when the received audio data has a lack of data in the frequency band. The signal processor 35 is executed by, for example, a general-purpose central processing unit (CPU), a digital signal processor (DSP), or a microcontroller. The DAC 36 converts digital audio data into analog audio data for output to the amplifier 37 and the output terminal O31. The amplifier 37 amplifies the analog audio data depending on the set volume for output to the output terminal O30.

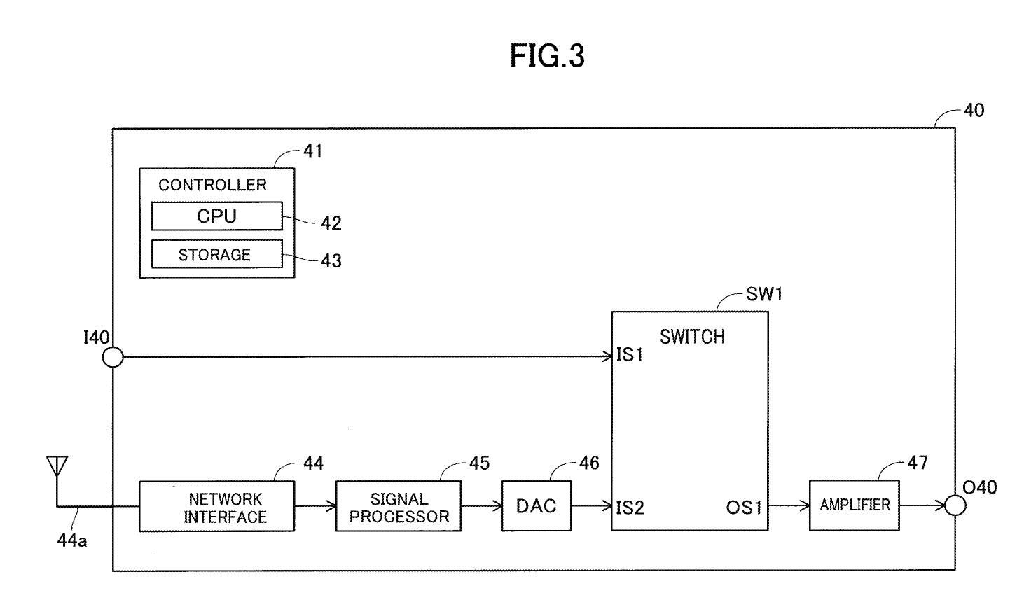

The second reproduction device 40 illustrated in FIG. 3 includes, for example, an input terminal 140, an output terminal O40, a controller 41, a network interface 44, a signal processor 45, a DAC 46, a switch SW1, and an amplifier 47.

The input terminal 140 is a terminal to which the audio cable 100 (described later with reference to FIG. 6) is to be connected, and the output terminal O40 is a terminal to which the speaker 52 is to be connected. The controller 41 includes, for example, a CPU 42 and a storage 43. The controller 41 has a function similar to that of the controller 31 of the first reproduction device 30, and controls, for example, the network interface 44, the signal processor 45, the DAC 46, the switch SW1, and the amplifier 47, which are connected thereto via a bus (not shown). The network interface 44 includes an antenna 44a, and has a function similar to that of the network interface 34 of the first reproduction device 30. The network interface 44 enables the second reproduction device 40 to communicate to/from, for example, the mobile terminal 10 and the first reproduction device 30 via the wireless LAN. The signal processor 45 to be connected to the network interface 44 outputs audio data, which has been created by executing predetermined signal processing on the received audio data, to the DAC 46. The DAC 46 connected to the signal processor 45 converts digital audio data into analog audio data for output to an input terminal IS2 of the switch SW1. The switch SW1 includes input terminals IS1 and IS2 and an output terminal OS1. The input terminal IS1 is connected to the input terminal I40. The switch SW1 switches the connection destination of the output terminal OS1 to the input terminal IS1 or IS2 in response to an instruction from the controller 41. The amplifier 47 is connected to the output terminal O40, and amplifies and outputs analog audio data depending on the set volume.

In this description, the first reproduction device 30 and the second reproduction device 40 are assumed to have different capabilities, and specifically, it is assumed that the signal processor 35 and the signal processor 45 are capable of processing different types of audio data. The formats of audio data that can be reproduced by the first reproduction device 30 are, for example, DSD, PCM, AAC, WAV, MP3, WMA, FLAC, ALAC, and AIFF. Meanwhile, the formats of audio data that can be reproduced by the second reproduction device 40 are, for example, PCM, WAV, MP3, and WMA, and the second reproduction device 40 cannot reproduce audio data in the DSD format.

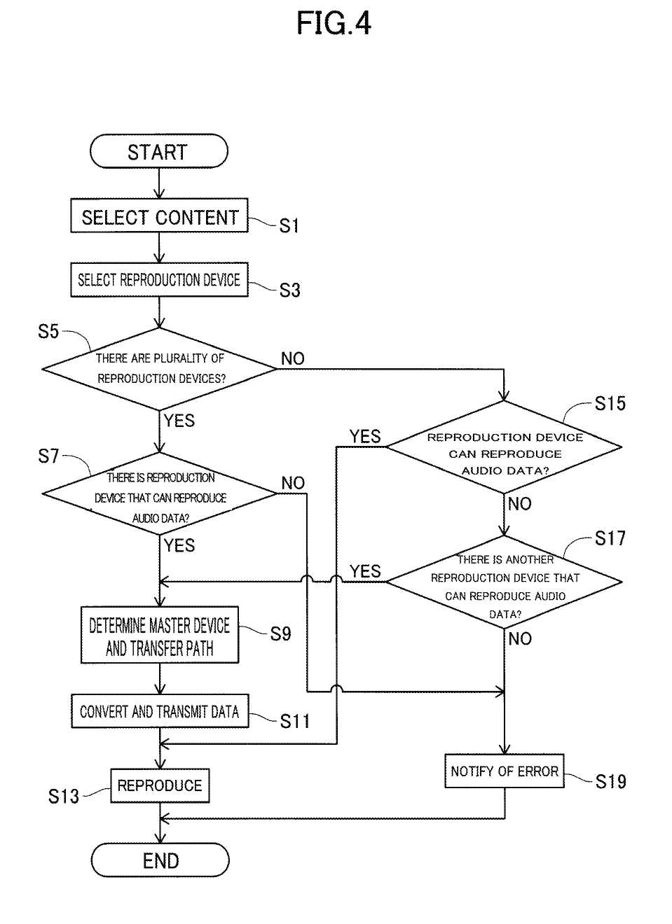

Next, a description is given of a flow in a case where the first reproduction device 30 and the second reproduction device 40 reproduce audio data with reference to a flowchart (FIG. 4) of reproduction processing. Now, a description is given of a case of selecting audio data in the DSD format.

In addition to the reproduction processing, the mobile terminal 10 executes setting processing of acquiring information on, for example, a reproduction device to be controlled and holding setting information in accordance with an application for controlling the first reproduction device 30 and the second reproduction device 40. The information on a reproduction device is, for example, the data format of audio data that can be reproduced by the reproduction device, details of executable signal processing, the capability of the amplifier, and information on connection between reproduction devices. The user performs a predetermined operation so that information indicating that reproduction devices included in the system 1 are the first reproduction device 30 and the second reproduction device 40 and information on the first reproduction device 30 and the second reproduction device 40 are stored in the storage 11 of the mobile terminal 10 as the setting information before execution of the reproduction processing.

When the user activates the application, the mobile terminal 10 starts the reproduction processing. First, the mobile terminal 10 displays a list of input sources. The input sources to be displayed are set in advance, and for example, are a “mobile terminal” and a “server”. The “mobile terminal” refers to the mobile terminal 10 operated by the user, and the “server” is, for example, a content server, a network attached storage (NAS), and a personal computer (PC), which is connected to the LAN. When the “server” is selected as the input source, the mobile terminal 10 displays the content server 3, which is a server connected to the LAN. When the user selects the content server 3, the mobile terminal 10 displays a list of audio data held by the content server 3 in, for example, a list format. When desired audio data in the DSD format is selected by the user (Step S1), the mobile terminal 10 next displays a list of reproduction devices registered in the mobile terminal 10. When the first reproduction device 30 and the second reproduction device 40 is selected as reproduction devices by the user (Step S3), the mobile terminal 10 determines whether or not there are a plurality of selected reproduction devices (Step S5). The user has selected the first reproduction device 30 and the second reproduction device 40, and thus the mobile terminal 10 determines that there are a plurality of reproduction devices (S5: YES), the mobile terminal 10 determines whether or not there is a reproduction device that can reproduce the selected audio data in the DSD format among the selected reproduction devices (Step S7). The mobile terminal 10 refers to the setting information stored in the storage 11, to determine that the selected audio data in the DSD format can be reproduced by the first reproduction device 30, and determines that there is a reproduction device that can reproduce the selected audio data (S7: YES).

Next, the mobile terminal 10 determines the first reproduction device 30, which can reproduce the selected audio data, as a master device, and determines a transfer path so that the first reproduction device 30 transmits audio data to the second reproduction device 40 (Step S9). The master device herein refers to a device that receives audio data from the content server 3. Next, the mobile terminal 10 instructs the first reproduction device 30, which is the master device, to receive audio data in the DSD format from the content server 3 via the wireless LAN and reproduce the audio data, and to convert the audio data in the DSD format into audio data in the PCM format and transmit the audio data to the second reproduction device 40 (Step S11). In response to the instruction, the first reproduction device 30 receives the audio data in the DSD format via the network interface 34, and transmits the audio data in the PCM format converted by the signal processor 35 to the second reproduction device 40 via the network interface 34. Further, the first reproduction device 30 transfers the received audio data in the DSD format to the signal processor 35, the DAC 36, and the amplifier 37 in the stated order, and the output terminal O30 outputs the audio data.

Further, the mobile terminal 10 instructs the second reproduction device 40 to reproduce the audio data transmitted from the first reproduction device 30. In response to the instruction, the controller 41 of the second reproduction device 40 instructs the switch SW1 to connect the input terminal IS2 and the output terminal OS1. As a result, the audio data in the PCM format transmitted from the first reproduction device 30 and received by the network interface 44 is transferred to the signal processor 45, the DAC 46, the switch SW1, and the amplifier 47 in the stated order, and the output terminal O40 outputs the audio data.

The speakers 51 and 52 emit sound based on audio data output from the first reproduction device 30 or the second reproduction device 40 (Step S13), and the reproduction processing ends. As a result, the first reproduction device 30 reproduces the audio data in the DSD format and the second reproduction device 40 reproduces the audio data in the PCM format so that pieces of audio data of the same content and of different formats can be reproduced. The first reproduction device 30 can reproduce audio data in the DSD format with a high sound quality without adjusting its data format to that of the second reproduction device 40. Even when the audio data provided from the content server 3 is audio data in the DSD format, which cannot be reproduced by the second reproduction device 40, the second reproduction device 40 can reproduce the audio data by receiving data converted by the first reproduction device 30. As a result, the system 1 can reproduce audio data of the same content without receiving, from the content server 3, two types of audio data, namely, audio data in the DSD format, which can be reproduced by the first reproduction device 30, and audio data in the PCM format, which can be reproduced by the second reproduction device 40.

Next, an additional description is given of the reproduction processing.

For example, a description is given of a case in which audio data in the DSD format is selected by the user (Step S1), and selects the second reproduction device 40 as a reproduction device (Step S3).

In this case, only the second reproduction device 40 is selected, and thus the mobile terminal 10 determines that there is a single reproduction device (S5: NO). Next, the mobile terminal 10 determines whether or not the selected reproduction device can reproduce the selected audio data (Step S15). The selected audio data in the DSD format cannot be reproduced by the selected second reproduction device 40, and thus the mobile terminal 10 determines that the selected reproduction device cannot reproduce the selected audio data in the DSD format (S15: NO), and next, the mobile terminal 10 determines whether or not there is another reproduction device that can reproduce the selected audio data in the DSD format (Step S17). The first reproduction device 30 can reproduce the selected audio data in the DSD format, and thus the mobile terminal 10 determines that there is another reproduction device that can reproduce the selected audio data in the DSD format (S17: YES), and proceeds to Step S9. The processing of Step S9 and its subsequent processing are executed in the manner described above, and the selected audio data is reproduced by the second reproduction device 40. In this case, sound output to the output terminal O30 of the first reproduction device 30 is muted so that the speaker 51 is prevented from emitting sound.

Next, a description is given of a case in which the audio data in the DSD format is selected by the user (Step S1) and the first reproduction device 30 is selected as the reproduction device (Step S3).

In this case, the first reproduction device 30 is selected, and thus the mobile terminal 10 determines that there is a single reproduction device (S5: NO). Next, the mobile terminal 10 executes Step S15. The selected first reproduction device 30 can reproduce the selected audio data in the DSD format, and thus the mobile terminal 10 determines that the selected reproduction device can reproduce the selected audio data in the DSD format (S15: YES), and then proceeds to Step S13. The processing of Step S13 and its subsequent processing are executed in the manner described above, and the selected audio data is reproduced by the first reproduction device 30.

When the user has selected audio data in a format that cannot be reproduced by any one of the first reproduction device 30 and the second reproduction device 40, the mobile terminal 10 notifies the user of an error which indicates that the audio data cannot be reproduced (Step S19). For example, when audio data in a format that cannot be reproduced by any one of the first reproduction device 30 and the second reproduction device 40 is selected (Step S1), and the first reproduction device 30 and the second reproduction device 40 are selected as reproduction devices (Step S3), the mobile terminal 10 determines that there are a plurality of reproduction devices (S5: YES), determines that there is no reproduction device that can reproduce the audio data (S7: NO), and proceeds to Step S19. For example, when audio data in a format that cannot be reproduced by any one of the first reproduction device 30 and the second reproduction device 40 is selected (Step S1) and, for example, the first reproduction device 30 is selected as a reproduction device (Step S3), the mobile terminal 10 determines that there is a single reproduction device (S5: NO), determines that the reproduction device cannot reproduce the audio data (S15: NO), determines that there is no other reproduction device that can reproduce the audio data (S17: NO), and proceeds to Step S19.

In the description of Step S9, the master device is determined based on the capability of converting one format to another, for example, the DSD format to the PCM format. Alternatively, for example, the master device maybe determined based on the capability of a codec, such as the reproduction capability of a so-called high-resolution sound source in which the sampling frequency is, for example, 96 kHz, 192 kHz, or 384 kHz in the PCM format or the PCM conversion capability of a sound stream such as Dolby (trademark) or DTS (trademark).

Next, a description is given of a modification example of the reproduction processing.

In the above, a description has been given of an example of selecting, in response to selection of content in the DSD format, a path passing through a reproduction device that can reproduce the content in the DSD format. However, a condition for selecting a path is not limited to content. The modification example is an example of selecting a transfer path depending on details of audio signal processing selected by the user.

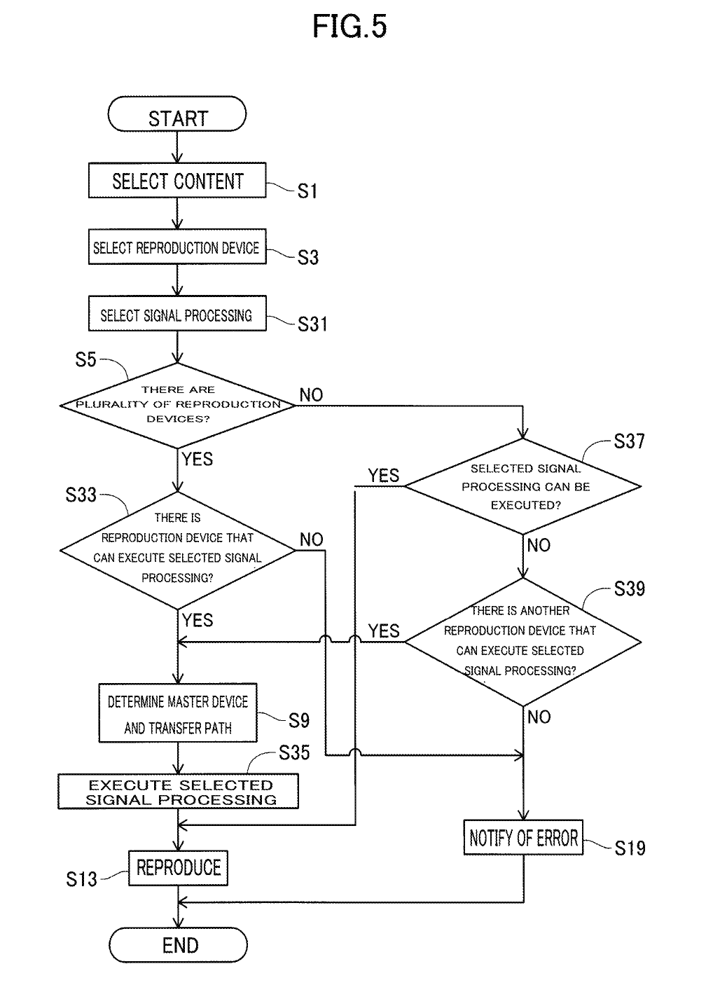

FIG. 5 is a flowchart in the modification example of the reproduction processing. In this flowchart, processing of selecting audio signal processing is added to the flow of FIG. 4. This example is a case of selecting the band expansion processing by the user.

As described above, the first reproduction device 30 can not only reproduce audio data, but can also improve the sound quality of audio data by executing band expansion processing on the audio data. In the reproduction processing of this modification example, Step S31, which is a step of selecting the sound signal processing by the user, is added. With this, the user can listen to sound of audio data subjected to desired audio signal processing without spending time and effort. The audio signal processing may be, for example, noise removal processing of removing noises, or may be equalizing processing of adjusting the level for each frequency band in addition to the band expansion processing. When the user desires reproduction of audio data subjected to the audio signal processing, in Step S31, the user can select desired audio signal processing. Audio signal processing that can be selected is “details of executable signal processing” contained in the setting information acquired by the mobile terminal 10 in the setting processing. It is assumed that the “details of executable signal processing” in the system 1 are only the band expansion processing, which can be executed by the first reproduction device 30. Now, a description is given of reproduction processing in this modification example taking a case of selecting the band expansion processing as an example with reference to FIG. 5. The same reference symbol is assigned to the same step as that of the reproduction processing in the first embodiment, and a detailed description thereof is appropriately omitted.

When audio data in a format that can be reproduced by any one of the first reproduction device 30 and the second reproduction device 40 are selected by the user (Step S1), and next, the second reproduction device 40 is selected as the reproduction device (Step S3), the mobile terminal 10 next proceeds to Step S31. In Step S31, as described above, the mobile terminal 10 refers to the setting information, and displays “band expansion processing”, which is audio signal processing that can be executed by a reproduction device included in the system 1. When “band expansion processing” is selected by the user, the mobile terminal 10 next proceeds to Step S5. The user selects the second reproduction device 40 as the reproduction device, and thus the mobile terminal 10 determines that there is a single reproduction device (S5: NO), and proceeds to Step S37. The “band expansion processing”, which is the selected audio signal processing, cannot be executed by the second reproduction device 40, and thus the mobile terminal 10 determines that the signal processing cannot be executed (S37: NO), and next, determines whether or not there is another reproduction device that can execute the signal processing (Step S39). The first reproduction device 30 can execute the band expansion processing, and thus the mobile terminal 10 determines that there is another reproduction device that can execute the signal processing (S39: YES). Then, the mobile terminal 10 proceeds to Step S9.

In Step S9, the mobile terminal 10 determines the first reproduction device 30, which can execute the band expansion processing, as the master device, and determines a transfer path for transfer of audio data from the first reproduction device 30 to the second reproduction device 40. Next, the mobile terminal 10 instructs the first reproduction device 30 serving as the master device to receive audio data from the content server 3 via the wireless LAN for reproduction, execute the band expansion processing on the audio data, and transmit the audio data subjected to the band expansion processing to the second reproduction device 40 (Step S35). The first reproduction device 30 receives the audio data via the network interface 34 in response to the instruction, and transmits the audio data subjected to the band expansion processing by the signal processor 35 to the second reproduction device 40 via the network interface 34. Further, the mobile terminal 10 instructs the second reproduction device 40 to reproduce the audio data transmitted from the first reproduction device 30. The speaker 52 emits sound in accordance with the audio data output from the second reproduction device 40 (Step S13), and ends the reproduction processing.

When audio data in a format that can be reproduced by any one of the first reproduction device 30 and the second reproduction device 40 are selected by the user (Step S1), the first reproduction device 30 and the second reproduction device 40 are selected as reproduction devices (Step S3), and “band expansion processing” is selected as the audio signal processing (Step S31), the mobile terminal 10 determines that there are a plurality of reproduction devices (S5: YES), and next, executes Step S33. In Step S33, the mobile terminal 10 determines whether or not there is a reproduction device that can execute the signal processing. The first reproduction device 30 can execute the band expansion processing, and thus the mobile terminal 10 determines that there is a reproduction device that can execute the signal processing (S33: NO), and proceeds to Step S9.

As described above, when the user desires reproduction of audio data subjected to desired audio signal processing, in Step S31, the user is only required to select desired audio signal processing, to thereby be able to reproduce the audio data subjected to the desired audio signal processing.

The signal processor 35 and the DAC 36 are an example of a first signal processor, and the signal processor 45 and the DAC 46 are an example of a second signal processor. Further, the conversion processing to be executed by the signal processor 35 is an example of signal processing and data conversion processing. Further, the band expansion processing to be executed by the signal processor 35 is an example of signal processing.

As described above, according to the first embodiment described above, the following effects are obtained.

In Step S3, when, by the user, the first reproduction device 30 and the second reproduction device 40, or the second reproduction device 40 are selected as the reproduction device, that is, in response to a request for reproduction of audio data by the second reproduction device 40, the mobile terminal 10 determines the master device that receives audio data from the content server 3 as the first reproduction device 30, and determines to transfer audio data from the first reproduction device 30 to the second reproduction device 40 (Step S9). The first reproduction device 30 converts audio data in the DSD format to audio data in the PCM format, and transfers the converted audio data in the PCM format to the second reproduction device 40 in response to an instruction from the mobile terminal 10. With this, even when the audio data provided by the content server 3 is audio data in the DSD format, which cannot be reproduced by the second reproduction device 40, the second reproduction device 40 can receive audio data in the PCM format, which can be reproduced by the second reproduction device 40, from the first reproduction device 30. Audio data of the same content can be reproduced without transfer of two types of audio data, namely, audio data in the DSD format, which can be processed by the first reproduction device 30, and audio data in the PCM format, which can be processed by the second reproduction device 40, also when the first reproduction device 30 and the second reproduction device 40 are desired to reproduce the audio data of the same content.

Next, a description is given of an entire configuration of a system 4 according to a second embodiment of the present invention with reference to FIG. 6. In the system 4, the output terminal O31 of the first reproduction device 30 and the input terminal 140 of the second reproduction device 40 are to be connected to each other via the audio cable 100, which transfers analog audio data, in addition to the configuration of the system 1 according to the first embodiment. With this, the second reproduction device 40 can reproduce analog audio data obtained through conversion by the first reproduction device 30.

In the first embodiment, a description has been given of, as an example of a difference in capabilities between the signal processor 35 of the first reproduction device 30 and the signal processor 45 of the second reproduction device 40, an example in which there is a difference between processing of the signal processor 35 and processing of the signal processor 45. However, in the second embodiment, it is assumed that the DAC 36 of the first reproduction device 30 and the DAC 46 of the second reproduction device 40 have different capabilities, and the DAC 36 of the first reproduction device 30 has a higher capability than that of the DAC 46 of the second reproduction device 40. In the first embodiment, a description has been given of an example of the case in which the signal processor 35 included in the first reproduction device 30 and the signal processor 45 included in the second reproduction device 40 can execute different signal processing. In the second embodiment, a description has been given of a case in which the DAC 36 included in the first reproduction device 30 and the DAC 46 included in the second reproduction device 40 have different capabilities. The DAC 36 has a higher capability than that of the DAC 46, and even when the same digital audio data is input, analog audio data obtained through conversion by the DAC 36 has a higher sound quality than that of analog audio data obtained through conversion by the DAC 46. The difference in capabilities herein includes differences in, for example, corresponding sampling frequencies, quantization bit rates, and SN ratios. A detailed description is given in the following.

The mobile terminal 10 executes setting processing similarly to the first embodiment in accordance with an application, and stores, into the storage 11, connection information indicating that the output terminal O31 of the first reproduction device 30 and the input terminal 140 of the second reproduction device 40 are to be connected to each other via the audio cable 100. The reproduction processing (refer to FIG. 4) is configured such that, when the determination results in “YES” in Step S15, the processing proceeds to Step S9.

For example, the user selects audio data in the PCM format, which can be reproduced by the second reproduction device 40, and when the second reproduction device 40 is selected in Step S3, the mobile terminal 10 determines that the second reproduction device 40 can reproduce the selected audio data in the PCM format (S15: YES), and proceeds to Step S9. As described above, in Step S9, the configuration of selecting a master device based on the capability of a reproduction device is adopted. As a result, in Step S9, the first reproduction device 30 including the DAC 36 with a higher capability is determined as the master device.

Next, the mobile terminal 10 instructs the first reproduction device 30 serving as the master device to transfer audio data in the PCM format, which is received from the content server 3 via the wireless LAN, to the network interface 34, the signal processor 35, and the DAC 36 in the stated order, and cause the output terminal O31 to output the audio data. The output terminal O31 of the first reproduction device 30 is connected to the input terminal 140 of the second reproduction device 40 via the audio cable 100, and thus the analog audio data output from the DAC 36 of the first reproduction device 30 is input to the second reproduction device 40 via the input terminal 140. Further, the mobile terminal 10 instructs the second reproduction device 40 to reproduce the audio data received via the input terminal 140. The controller 41 of the second reproduction device 40 instructs the switch SW1 to connect the input terminal IS1 and the output terminal OS1 in response to the instruction. With this, the audio data in the PCM format, which has been transmitted from the first reproduction device 30 and received via the input terminal 140, is transferred to the switch SW1 and the amplifier 47 in the stated order, and the output terminal O40 outputs the audio data. The speaker 52 emits sound of the audio data selected by the user. As a result, the user can listen to the sound of the audio data with a higher sound quality.

The processing of converting digital audio data to analog audio data, which is to be executed by the DAC 36 included in the first reproduction device 30, is an example of signal processing.

According to the second embodiment described above, the second reproduction device 40 can receive, from the first reproduction device 30, analog audio data with a higher sound quality than that of analog audio data that is obtained through conversion by the DAC 46 of the second reproduction device 40.

It should be understood that the present invention is not limited to the embodiments described above, and may be subjected to various improvements and modifications without departing from the gist of the present invention.

For example, a description has been given of a case in which the systems 1 and 4 each include the first reproduction device 30 and the second reproduction device 40. However, the systems 1 and 4 may each include three or more reproduction devices. For example, when the systems 1 and 4 each include three or more reproduction devices, in Step S9, the mobile terminal 10 may be configured to determine the master device and the transfer path in accordance with priorities determined in advance in terms of whether or not the audio data can be reproduced, details of executable signal processing, and the capability of the DAC. For example, when there are a plurality of reproduction devices that can reproduce audio data selected by the user, the mobile terminal 10 next compares the capabilities of DACs with one another, and determines a reproduction device whose DAC has the highest capability as the master device.

Further, a description has been given of a case in which, in the reproduction processing (refer to FIG. 4), the processing proceeds to Step S13 in response to the determination of “YES” in Step S15. However, the processing may proceed to Step S9 instead. The first reproduction device 30 can execute the band expansion processing, whereas the second reproduction device 40 cannot execute the band expansion processing. Thus, for example, when, in Step S1, the user selects audio data in the PCM format, which can also be reproduced by the second reproduction device 40, in Step S3, the second reproduction device 40 is selected, and in Step S5, the determination results in “NO”, the second reproduction device 40 does not receive and reproduce the audio data and the processing proceeds to Step S9, although the second reproduction device 40 can reproduce the selected audio data in the PCM format (S15: YES). In the above, a description has been given of a case in which, in Step S9, the mobile terminal 10 determines the master device based on whether or not the audio data can be reproduced. However, in addition to this configuration, the mobile terminal 10 is configured to select the master device based on the capability of the reproduction device. Specifically, when received digital audio data is converted to analog audio data, a device capable of converting the digital audio data to audio data with a higher sound quality is set as the master device. Thus, the first reproduction device 30 capable of executing the band expansion processing is set as the master device. With this, the second reproduction device 40 can receive audio data via the first reproduction device 30 to reproduce audio data with a high sound quality. Processing of Step S9 and its subsequent processing may be executed in the same manner as described above.

Further, in the above description, the mobile terminal 10 determines (Step S9) the master device every time the system 1 or 4 reproduces audio data in the reproduction processing. However, the processing step (Step S9) of determining the master device and the transfer path may be separated from the reproduction processing, and for example, may be included in the setting processing. Further, in the above description, the mobile terminal 10 executes the processing of Step S9. However, the user may determine the master device and the transfer path.

Further, the configurations of the first reproduction device 30 and the second reproduction device 40 are not limited to the above-mentioned configurations. The first reproduction device 30 may further include, for example, an input terminal to which an audio cable is to be connected and a switch, or the second reproduction device 40 may further include, for example, an output terminal to which an audio cable is to be connected and a signal processor. Further, the first reproduction device 30 and the second reproduction device 40 may incorporate speakers.

Further, in the above description, the mobile terminal 10 functions as the controller in the systems 1 and 4. However, the controller is not limited thereto. For example, a PC that can use a controller application or a remote controller attached to the reproduction device may be set as the controller. Further, in the above description, the first reproduction device 30 or the second reproduction device 40 receives audio data from the content server 3. However, the provider of data is not limited thereto. For example, the present application can be applied to a configuration in which audio data is received from a storage of a PC or a network attached storage (NAS), which is to be connected to a LAN.

Further, in the above description, the first reproduction device 30 and the second reproduction device 40 communicate to/from each other via a wireless LAN. However, the communication standard is not limited thereto. For example, the present application can be applied to wired LAN communication.

In the above description, the controllers 31 and 41 are constructed of such components as the CPUs 32 and 42 and the storages 33 and 43, respectively. However, the controllers 31 and 41 may be implemented by a group of circuits, for example, an application specific integrated circuit (ASIC).

Further, in the above description, the zones Z1 and Z2 are, for example, a kitchen and a living room, respectively. However, the zone is not limited to a residential building. For example, the present application can be applied to a public address (PA) used in a facility such as a music venue or an event venue. Further, the first reproduction device 30 and the second reproduction device 40 may be arranged in the same zone.

### [Supplementary Notes]

As can be understood from the above description of the embodiment, in the present application, a variety of technical ideas including embodiments of the invention described below are disclosed.

According to one embodiment of the present invention, there is provided a system including: a first reproduction device including a first signal processor and being configured to reproduce audio data; and a second reproduction device configured to reproduce the audio data, wherein the first reproduction device is configured to: receive the audio data from a content server providing the audio data in response to a request for reproduction of the audio data by the second reproduction device; cause the first signal processor to execute predetermined signal processing on the received audio data; and transfer the audio data subjected to the predetermined signal processing to the second reproduction device.

As a result, for example, even when the audio data provided from the content server is audio data in a format that cannot be reproduced by the second reproduction device, the second reproduction device can receive audio data in a data format that can be reproduced by the second reproduction device from the first reproduction device. According to one embodiment of the present invention, it is possible to achieve reproduction with a sound quality that suits the capability of each device through transfer of the smallest amount of audio data possible by providing audio data in a data format processable by each device.

According to one embodiment of the present invention, the audio data stored in the content server is digital data in a first data format, and the predetermined signal processing is data conversion processing of converting audio data in the first data format to audio data in a second data format different from the first data format.

According to one embodiment of the present invention, the second reproduction device includes a second signal processor, the first signal processor is capable of reproducing data in the first data format, and the second signal processor is capable of reproducing data in the second data format.

According to one embodiment of the present invention, the predetermined signal processing is audio signal processing for improving a sound quality of the audio data.

According to one embodiment of the present invention, the audio signal processing is any one of band expansion processing of expanding a frequency band, noise removal processing of removing a noise, and equalizing processing of adjusting a level for each frequency band.

According to one embodiment of the present invention, the system further includes a control terminal, and the control terminal is configured to control the first reproduction device and the second reproduction device based on information on the first reproduction device and the second reproduction device.

According to one embodiment of the present invention, the control terminal is configured to: determine whether a plurality of reproduction devices have been selected by a user; determine, when the plurality of reproduction devices have been selected, whether there is a reproduction device capable of reproducing audio data in a data format selected by the user among the plurality of selected reproduction devices; and determine, when a single reproduction device has been selected, whether the selected single reproduction device is capable of reproducing the audio data in the data format selected by the user.

According to one embodiment of the present invention, when: the audio data selected by the user is audio data in a first data format; and the plurality of reproduction devices selected by the user are the first reproduction device capable of reproducing audio data in the first data format, and the second reproduction device incapable of reproducing audio data in the first data format and capable of reproducing audio data in a second data format different from the first data format, the control terminal causes the first reproduction device to receive the audio data in the first data format from the content server and reproduce the audio data, convert the received audio data in the first data format to audio data in the second data format, and transmit the audio data in the second data format to the second reproduction device, and the control terminal further causes the second reproduction device to reproduce the audio data in the second data format transmitted from the first reproduction device.

According to one embodiment of the present invention, when: the audio data selected by the user is audio data in a first data format; and the single reproduction device selected by the user is incapable of reproducing audio data in the first data format and capable of reproducing audio data in a second data format different from the first data format, the control terminal further determines whether or not there is another reproduction device capable of reproducing audio data in the first data format.

According to one embodiment of the present invention, when the first reproduction device is capable of reproducing audio data in the first data format, the control terminal causes the first reproduction device to receive the audio data in the first data format from the content server, convert the received audio data in the first data format to audio data in the second data format, and transmit the audio data in the second data format to the second reproduction device, and the control terminal further causes the second reproduction device to reproduce the audio data in the second data format transmitted from the first reproduction device.

According to one embodiment of the present invention, the control terminal is further configured to control the first reproduction device so that the first reproduction device is prevented from outputting the received audio data in the first data format to a speaker.

Further, according to one embodiment of the present invention, there is provided a control method including: receiving, by a first reproduction device including a first signal processor and being configured to reproduce audio data, the audio data from a content server configured to provide the audio data, in response to a request for reproduction of the audio data by a second reproduction device configured to reproduce the audio data; causing, by the first reproduction device, the first signal processor to execute predetermined signal processing on the received audio data; and transferring, by the first reproduction device, the audio data subjected to the predetermined signal processing to the second reproduction device.

Further, according to one embodiment of the present invention, there is provided a control terminal, which is configured to: cause a first reproduction device including a first signal processor and being configured to reproduce audio data to receive the audio data from a content server configured to provide the audio data, in response to a request for reproduction of the audio data by a second reproduction device configured to reproduce the audio data; cause the first reproduction device to cause the first signal processor to execute predetermined signal processing on the received audio data; and cause the first reproduction device to transfer the audio data subjected to the predetermined signal processing to the second reproduction device.

According to one embodiment of the present invention, the control terminal is configured to: acquire information on the first reproduction device and the second reproduction device; and control the first reproduction device and the second reproduction device based on the acquired information.

According to one embodiment of the present invention, the control terminal is configured to: determine whether a plurality of reproduction devices have been selected by a user; determine, when the plurality of reproduction devices have been selected, whether there is a reproduction device capable of reproducing audio data in a data format selected by the user among the plurality of selected reproduction devices; and determine, when a single reproduction device has been selected, whether the selected single reproduction device is capable of reproducing the audio data in the data format selected by the user.

Further, according to one embodiment of the present invention, there is provided a computer-readable information storage medium having stored thereon a program for causing a computer to function as a controller configured to : cause a first reproduction device including a first signal processor and being configured to reproduce audio data to receive the audio data from a content server configured to provide the audio data, in response to a request for reproduction of the audio data by a second reproduction device configured to reproduce the audio data; cause the first reproduction device to cause the first signal processor to execute predetermined signal processing on the received audio data; and cause the first reproduction device to transfer the audio data subjected to the predetermined signal processing to the second reproduction device.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A system, comprising:
a first reproduction device including a first signal processor and being configured to reproduce audio data; and
a second reproduction device configured to reproduce the audio data;
wherein the first reproduction device is configured to:
receive the audio data from a content server providing the audio data in response to a request for reproduction of the audio data by the second reproduction device;
cause the first signal processor to execute predetermined signal processing on the received audio data; and
transfer the audio data subjected to the predetermined signal processing to the second reproduction device.

2. The system according to claim 1,
wherein the audio data stored in the content server includes digital data in a first data format, and
wherein the predetermined signal processing includes data conversion processing of converting audio data in the first data format to audio data in a second data format different from the first data format.

3. The system according to claim 2,
wherein the second reproduction device includes a second signal processor,
wherein the first signal processor is capable of reproducing data in the first data format, and
wherein the second signal processor is capable of reproducing data in the second data format.

4. The system according to claim 1, wherein the predetermined signal processing includes audio signal processing for improving a sound quality of the audio data.

5. The system according to claim 4, wherein the audio signal processing includes any one of band expansion processing of expanding a frequency band, noise removal processing of removing a noise, and equalizing processing of adjusting a level for each frequency band.

6. The system according to claim 1, further comprising a control terminal,
wherein the control terminal is configured to control the first reproduction device and the second reproduction device based on information on the first reproduction device and the second reproduction device.

7. The system according to claim 6, wherein the control terminal is configured to:
determine whether a plurality of reproduction devices have been selected by a user;
determine, when the plurality of selected reproduction devices have been selected, whether there is a reproduction device capable of reproducing audio data in a data format selected by the user among the plurality of selected reproduction devices; and
determine, when a single reproduction device has been selected, whether the selected single reproduction device is capable of reproducing the audio data in the data format selected by the user.

8. The system according to claim 7, wherein, when:
the audio data selected by the user is audio data in a first data format; and
the plurality of reproduction devices selected by the user are the first reproduction device capable of reproducing audio data in the first data format, and the second reproduction device incapable of reproducing audio data in the first data format and capable of reproducing audio data in a second data format different from the first data format,
the control terminal causes the first reproduction device to receive the audio data in the first data format from the content server and reproduce the audio data, convert the received audio data in the first data format to audio data in the second data format, and transmit the audio data in the second data format to the second reproduction device, and
the control terminal further causes the second reproduction device to reproduce the audio data in the second data format transmitted from the first reproduction device.

9. The system according to claim 7, wherein, when:
the audio data selected by the user is audio data in a first data format; and
the single reproduction device selected by the user is incapable of reproducing audio data in the first data format and capable of reproducing audio data in a second data format different from the first data format,
the control terminal further determines whether there is another reproduction device capable of reproducing audio data in the first data format.

10. The system according to claim 9,
wherein, when the first reproduction device is capable of reproducing audio data in the first data format, the control terminal causes the first reproduction device to receive the audio data in the first data format from the content server, convert the received audio data in the first data format to audio data in the second data format, and transmit the audio data in the second data format to the second reproduction device, and
wherein the control terminal further causes the second reproduction device to reproduce the audio data in the second data format transmitted from the first reproduction device.

11. The system according to claim 10, wherein the control terminal is further configured to control the first reproduction device so that the first reproduction device is prevented from outputting the received audio data in the first data format to a speaker.

12. A control method, comprising:
receiving, by a first reproduction device including a first signal processor and being configured to reproduce audio data, the audio data from a content server configured to provide the audio data, in response to a request for reproduction of the audio data by a second reproduction device configured to reproduce the audio data;
causing, by the first reproduction device, the first signal processor to execute predetermined signal processing on the received audio data; and
transferring, by the first reproduction device, the audio data subjected to the predetermined signal processing to the second reproduction device.

13. The control method according to claim 12,
wherein the audio data stored in the content server includes digital data in a first data format, and
wherein the predetermined signal processing includes data conversion processing of converting audio data in the first data format to audio data in a second data format different from the first data format.

14. The control method according to claim 13,
wherein the second reproduction device includes a second signal processor,
wherein the first signal processor is capable of reproducing data in the first data format,
wherein the second signal processor is capable of reproducing data in the second data format, and
wherein transferring the audio data includes transferring, by the first reproduction device, the audio data subjected to the predetermined signal processing to the second reproduction device including the second signal processor.

15. The control method according to claim 12, wherein the predetermined signal processing includes audio signal processing for improving a sound quality of the audio data.

16. The control method according to claim 15,
wherein the audio signal processing includes band expansion processing of expanding a frequency band, noise removal processing of removing a noise, and equalizing processing of adjusting a level for each frequency band.

17. The control method according to claim 12, further comprising controlling, by a control terminal, the first reproduction device and the second reproduction device based on information on the first reproduction device and the second reproduction device.

18. A control terminal, which is configured to:
cause a first reproduction device including a first signal processor and being configured to reproduce audio data to receive the audio data from a content server configured to provide the audio data, in response to a request for reproduction of the audio data by a second reproduction device configured to reproduce the audio data;
cause the first reproduction device to cause the first signal processor to execute predetermined signal processing on the received audio data; and
cause the first reproduction device to transfer the audio data subjected to the predetermined signal processing to the second reproduction device.

19. The control terminal according to claim 18, wherein the control terminal is configured to:
acquire information on the first reproduction device and the second reproduction device; and
control the first reproduction device and the second reproduction device based on the acquired information.

20. The control terminal according to claim 19, wherein the control terminal is configured to:
determine whether a plurality of reproduction devices have been selected by a user;
determine, when the plurality of reproduction devices have been selected, whether there is a reproduction device capable of reproducing audio data in a data format selected by the user among the plurality of selected reproduction devices; and
determine, when a single selected reproduction device has been selected, whether the selected single reproduction device is capable of reproducing the audio data in the data format selected by the user.
